(19) United States
(12) Patent Application Publication
(10) Pub. No.: US 2025/0313271 A1
(43) Pub. Date: Oct. 9, 2025

(54) RAIL GARNISH

(71) Applicant: TOYOTA JIDOSHA KABUSHIKI KAISHA, Toyota-shi (JP)

(72) Inventors: Motoya SAKABE, Nissin-shi (JP); Kouichirou UENO, Nagoya-shi (JP); Shintaro KITAKATA, Nissin-shi (JP)

(73) Assignee: TOYOTA JIDOSHA KABUSHIKI KAISHA, Toyota-shi (JP)

(21) Appl. No.: 19/056,942

(22) Filed: Feb. 19, 2025

(30) Foreign Application Priority Data
Apr. 4, 2024 (JP) 2024-060866

(51) Int. Cl. B62D 25/02

(52) U.S. Cl. CPC B62D 25/02

(57) ABSTRACT

The rail garnish fitted to the upper arch structure includes a garnish main body extending along the upper arch structure, a plurality of clips arranged along a longitudinal direction of the garnish main body, and a protrusion protruding toward the upper arch structure. The clip is inserted into an attachment hole formed in an outer side face of the upper arch structure to secure the rail garnish to the upper arch structure. The protrusion abuts the upper surface of the upper arch structure and stabilizes the position of the rail garnish relative to the upper arch structure.

### CROSS-REFERENCE TO RELATED APPLICATION

This application claims priority to Japanese Patent Application No. 2024-060866 filed on Apr. 4, 2024, incorporated herein by reference in its entirety.

### BACKGROUND

### 1. Technical Field

The present disclosure relates to a rail garnish that is fitted to an upper arch structure of a side framework structure of a vehicle.

### 2. Description of Related Art

A side framework structure of a vehicle such as an automobile, for example, includes a plurality of pillars erected on a vehicle body base structure, and roof side rails extending along a front-rear direction of the vehicle so as to connect upper ends of these pillars. A roof is provided between the right and left roof side rails, and the pillars support the roof via the roof side rails. Front pillars are inclined backward along an inclination of a windshield, and are connected to front ends of the roof side rails at rear ends thereof. The front pillars and the roof side rails are generally arcuate in shape as a whole as viewed sideward, and structures made up of the front pillars and the roof side rails are hereinafter each referred to as an “upper arch structure”. Rail garnishes are known that are fitted to the upper arch structure so as to cover a surface of the upper arch structure on an outer side of a vehicle body.

Japanese Unexamined Patent Application Publication No. 2019-26239 (JP 2019-26239 A) describes a rail garnish (16) covering an upper arch structure (roof side rail 80). The rail garnish (16) is fixed to the upper arch structure (80) by clips (16A). Note that the above-mentioned member names and reference numerals in parentheses are those used in JP 2019-26239 A, and do not relate to the member names and reference numerals used in the description of the embodiments of the present application.

### SUMMARY

A position of the rail garnish relative to the upper arch structure has to be firmly set. The present disclosure provides a structure for stabilizing a position when a rail garnish is fitted to an upper arch structure.

The rail garnish according to the present disclosure includes a garnish main body that extends along an upper arch structure that is a part of a vehicle body-side framework structure, a plurality of clips that is disposed on the garnish main body and that fixes the rail garnish to the upper arch structure, and
a protruding portion that is provided on the garnish main body, and that abuts the upper arch structure.

The clips are disposed on a face of the garnish main body opposing one face of an outer side face of the upper arch structure facing an outer side in a vehicle-width direction, and an upper face of the upper arch structure. The clips are inserted into attachment holes opened in the one face of the upper arch structure and fix the rail garnish to the upper arch structure. The protruding portion protrudes from a face of the garnish main body facing the other face of the outer side face of the upper arch structure and the upper face. The protruding portion abuts the other face of the upper arch structure.

A position of the rail garnish with respect to the upper arch structure can be stabilized, due to the protruding portion abutting the upper arch structure.

The protruding portion may be a plurality of protrusions arrayed along the garnish main body. Flexibility in a longitudinal direction of the rail garnish is ensured, and conforming to the form of the upper arch structure is facilitated.

Each of the protrusions may be disposed at a position between the clips in the direction in which the garnish main body extends. Interference between clip seats to which the clips are fitted and the protrusions of the garnish main body is circumvented.

The garnish main body may include a garnish outer member that makes up an aesthetic surface of a vehicle, and a garnish inner member that is situated on the upper arch structure side of the garnish outer member, and the garnish inner member may be fitted with the clips and be provided with the protrusions. The clip seats and the protrusions, for fitting the clips to the garnish inner member that is separate from the garnish outer member making up the aesthetic surface, are formed. Thus, effects on the shape of the aesthetic surface, due to directly forming the clip seats and the protrusions on the member forming the aesthetic surface, are suppressed.

The protrusions may be fabricated integrally with the garnish inner member. Manufacturing processes of the rail garnish are simplified.

The position of the rail garnish with respect to the upper arch structure can be stabilized due to the protruding portion of the rail garnish abutting the upper arch structure, and the appearance of the proximity of the upper arch structure is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view illustrating a vehicle body-side framework structure of a vehicle;

FIG. 2 is a cross-sectional view of the upper arch structure, in particular the roof side rail, taken along II-II line shown in FIG. 1, showing a section of the clipped position;

FIG. 3 is a cross sectional view by III-III line shown in the FIG. 1 of an upper arch structure, particularly a roof side rail, and is the figure showing the section of the position where the protrusion was provided; and

FIG. 4 is a diagram illustrating a garnish inner member.

### DETAILED DESCRIPTION OF EMBODIMENTS

Hereinafter, embodiments of the present disclosure will be described with reference to the drawings. In the following description, unless otherwise specified, terms representing relative positions and orientations, such as front, rear, left, right, up, down, etc., represent relative positions and orientations with respect to a vehicle. In addition, a side close to a center line extending in the front-rear direction of the vehicle in the left-right direction (width direction) of the vehicle is referred to as a vehicle width direction inner side, and a far side is referred to as a vehicle width direction outer side. In the drawings, the direction of the arrow FR is forward, the direction of the arrow UP is upward, the direction of the arrow LH is leftward, and the direction of the arrow OUT is outward in the vehicle widthwise direction.

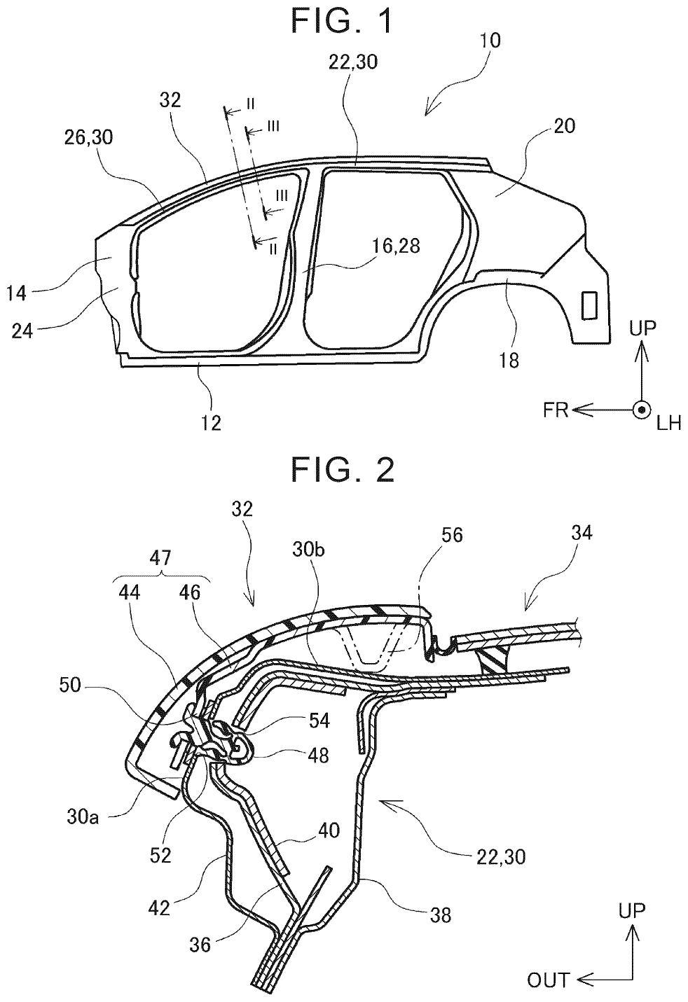

FIG. 1 is a side view illustrating a vehicle body-side framework structure 10 of a vehicle. The vehicle body-side framework structure 10 includes a rocker portion 12, a front columnar member 14, a center columnar member 16, a rear wheelhouse portion 18, a rear columnar member 20, and a roof side rail 22.

The rocker portion 12 constitutes the left and right side portions of the floor structure defining the bottom portion of the vehicle, and extends along the front-rear direction. The front columnar member 14 is erected on the front end portion of the rocker portion 12, and the center columnar member 16 is erected on the center portion in the front-rear direction of the rocker portion 12. The rear wheelhouse portion 18 is connected to a rear end of the rocker portion 12 and is positioned so as to surround an upper portion of a rear wheel (not shown). The rear columnar member 20 is provided on the rear wheelhouse portion 18. The roof side rail 22 extends along the front-rear direction along the side edge of the roof, and is provided so as to connect the upper ends of the front columnar member 14, the center columnar member 16, and the rear columnar member 20.

The front columnar member 14 includes a dash panel side portion 24 extending substantially vertically upward from a front end portion of the rocker portion 12, and a front pillar 26 extending upward and rearward from an upper end of the dash panel side portion 24 and extending to the roof side rail 22. The front pillar 26 is located at a boundary between a windshield (not shown) and a window of a front door (not shown). The center columnar member 16 is a center pillar 28 located between the front seat and the rear seat.

The front pillar 26 and the roof side rail 22 have an arched shape as a whole when viewed from the side, and form an upper arch structure 30 located above the vehicle body-side framework structure 10. At least one part of the front pillar 26 and the roof side rail 22 may extend over the front pillar 26 and the roof side rail 22 and may extend until reaching the rear columnar member 20.

The rail garnish 32 is fitted to the upper arch structure 30. The rail garnish 32 covers the outwardly facing surface of the upper arch structure 30 of the vehicle to enhance the appearance of the vehicle. The rail garnish 32 may be disposed entirely or partially corresponding to the front-rear direction of the upper arch structure 30.

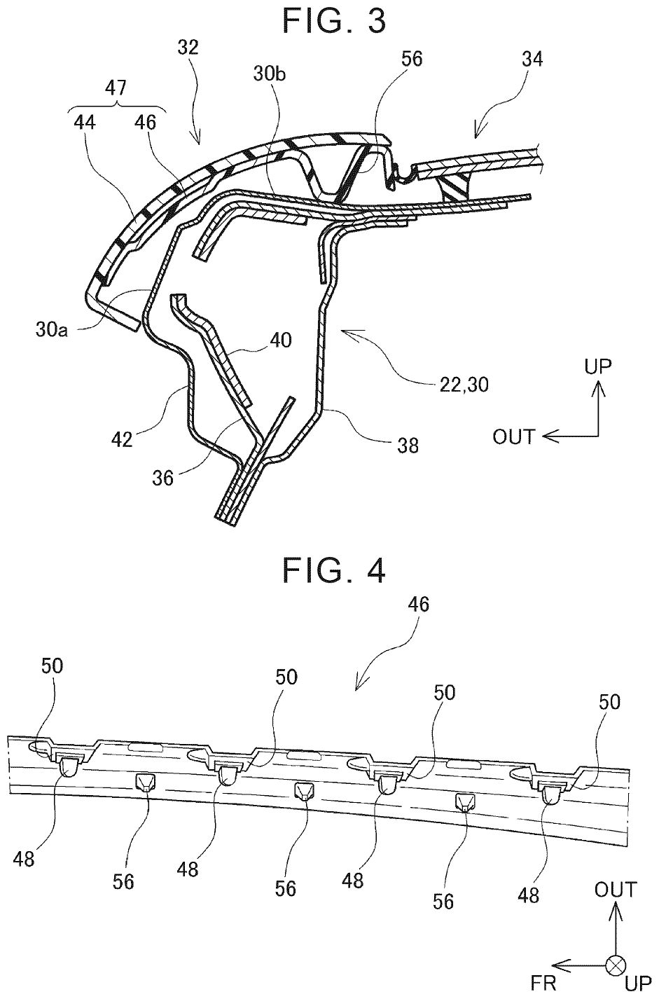

FIGS. 2 and 3 are cross-sectional views of the upper arch structure 30 and the rail garnish 32. FIG. 2 is a cross-sectional view taken along II-II line shown in FIG. 1, and FIG. 3 is a cross-sectional view taken along III-III line shown in FIG. 1. The cross sections shown in FIGS. 2 and 3 are cross sections of portions of the roof side rail 22, in particular, cross sections near the leading edge of the roof 34.

The roof side rail 22 includes a rail outer member 36 and a rail inner member 38 extending in the front-rear direction. In the rail outer member 36 and the rail inner member 38, the rail outer member 36 is positioned on the outer side of the vehicle body and the rail inner member 38 is positioned on the inner side of the vehicle body. Each of the rail outer member 36 and the rail inner member 38 is welded to form a closed cross-sectional structure. A reinforcing member 40 may additionally be disposed within the closed cross-sectional structure. The roof side rail 22 has an outer panel 42 disposed on the outer side of the rail outer member 36. The outer panel 42 may be welded together with the rail outer member 36 and the rail inner member 38. The front pillar 26 also has a cross-sectional shape similar to that of the roof side rail 22. At least one of the rail outer member 36, the rail inner member 38, and the outer panel 42 may extend from the roof side rail 22 to the front pillar 26.

The rail garnish 32 is disposed so as to cover an upper part of the side face 30a of the upper arch structure 30 facing outward in the vehicle-width direction and an upper face 30b of the upper arch structure 30 facing upward. The lateral 30a facing outward in the vehicle-width direction is referred to as an “outer side face 30a”. The rail garnish 32 includes a garnish outer member 44 constituting a part of an aesthetic surface of the vehicle, and a garnish inner member 46 disposed inside the garnish outer member 44. A garnish outer member 44 covers the upper portion and the upper face 30b of the outer side face 30a of the upper arch structure 30, and a garnish inner member 46 is disposed on the inner side thereof so as to be substantially invisible from the outside. The garnish inner member 46 is also disposed to correspond to the upper portion and the upper face 30b of the outer side face 30a of the upper arch structure 30. The one rail garnish 32 may be formed from one garnish outer member 44 and a plurality of garnish inner members 46 divided into several portions in the longitudinal direction of the rail garnish 32. The garnish outer member 44 and the garnish inner member 46 may be made of resin, and may be joined to each other by welding, bonding, or the like.

The rail garnish 32 includes a garnish main body 47 composed of a garnish outer member 44 and a garnish inner member 46, and a clip 48 for fitting the garnish main body 47 to the upper arch structure 30. A clip seat 50 to which the clip 48 is fitted is formed in the garnish inner member 46. A clip 48 mounted to the clip seat 50 is inserted into an attachment hole 52 formed in the outer panel 42 of the upper arch structure 30 and snaps fit to secure the rail garnish 32 to the upper arch structure 30. The rail outer member 36 and the reinforcing member 40 may be formed with a clearance hole 54 for avoiding interference with the clip 48. The clips 48 are arranged at a plurality of intervals along the longitudinal direction of the rail garnish 32.

On a surface of the garnish inner member 46 facing the upper face 30b of the upper arch structure, a protrusion 56 protruding from this surface and abutting on the upper face 30b at the distal end is formed. The protrusion 56 is located away from the side edge of the garnish main body 47. The protrusion 56 may be integrally formed with the garnish inner member 46. When the rail garnish 32 is fitted to the upper arch structure 30, the protrusion 56 is biased toward the upper arch structure 30 by the elasticity of the rail garnish 32. The biasing force causes the protrusion 56 to constantly touch the upper face 30b of the upper arch structure. The abutment of the protrusion 56 against the upper face 30b stabilizes the position of the rail garnish 32 relative to the upper arch structure 30, in particular the position of the edge adjoining the roof 34.

FIG. 4 is a diagram illustrating a state in which the garnish inner member 46 is disposed in a state when the garnish inner member is fitted on the vehicle body and is looked up from below. The protrusion 56 has a substantially conical shape or a frustum shape in which the tip of the cone is cut off, and the tip is in contact with the upper face 30b of the upper arch structure. The contact between the protrusion 56 and the upper face 30b may be a point contact, or a surface contact in which the contact area is substantially equal in size to the front-rear direction and the left-right direction, such as a circle. The protrusions 56 are arranged along the longitudinal direction of the rail garnish 32. Further, the protrusions 56 may be arranged corresponding to positions between the longitudinally arranged clips 48. In the longitudinal direction of the rail garnish 32, the protrusions 56 and the clips 48 may be arranged alternately. Instead of the substantially cone-shaped or trapezoidal-shaped protrusion 56, a protruding portion having a raised shape long in the front-rear direction may be provided. The ridge-shaped protruding portion may extend over the entire length of the rail garnish 32.

In the rail garnish 32 described above, the clips 48 are disposed corresponding to the outer side face 30a of the upper arch structure 30, and the protrusions 56 are disposed corresponding to the upper face 30b of the upper arch structure 30. Alternatively, the clip and the protrusion may be replaced. That is, a clip may be correspondingly disposed on the upper face 30b of the upper arch structure 30, and the clip may be inserted into a hole provided in the upper face 30b to snap-fit the clip, so that the protrusion abuts on the outer side face 30a of the upper arch structure 30.

In the rail garnish 32 described above, the garnish main body 47 is constituted by two members, namely, a garnish outer member 44 and a garnish inner member 46, and a clip 48 is fitted to the garnish inner member 46 and a protrusion 56 is provided. Alternatively, the garnish main body may be formed of a single member, and the clip may be directly fitted to the garnish main body, and a protrusion corresponding to the protrusion 56 may be provided.

What is claimed is:

1. A rail garnish, comprising:
a garnish main body that is fitted onto an upper arch structure of a vehicle body-side framework structure and that extends along the upper arch structure;
a plurality of clips arrayed on a face of the garnish main body opposing one face of an outer side face of the upper arch structure facing an outer side in a vehicle-width direction, and an upper face of the upper arch structure, the clips being arrayed along a direction in which the garnish main body extends, and being inserted into attachment holes opened in the one face of the upper arch structure and fixing the rail garnish to the upper arch structure; and
a protruding portion that protrudes from a face of the garnish main body facing the other face of the outer side face of the upper arch structure and the upper face, and that abuts the other face of the upper arch structure.

2. The rail garnish according to claim 1, wherein the protruding portion is a plurality of protrusions arrayed along the garnish main body.

3. The rail garnish according to claim 2, wherein each of the protrusions is disposed at a position between the clips in the direction in which the garnish main body extends.

4. The rail garnish according to claim 2, wherein the garnish main body includes a garnish outer member that makes up an aesthetic surface of a vehicle, and a garnish inner member that is situated on the upper arch structure side of the garnish outer member, and the garnish inner member is fitted with the clips and provided with the protrusions.

5. The rail garnish according to claim 4, wherein the protrusions are fabricated integrally with the garnish inner member.
